(19) United States
(12) Patent Application Publication
(10) Pub. No.: US 2012/0088582 A1
(43) Pub. Date: Apr. 12, 2012

(54) SEPARABLE GAME CONTROLLER

(75) Inventors: Chun-Che Wu, Taipei (TW); Chun-Nan Su, Taipei (TW); Shu-Wei Chou, Taipei (TW)

(73) Assignee: PRIMAX ELECTRONICS LTD., Taipei (TW)

(21) Appl. No.: 12/960,250

(22) Filed: Dec. 3, 2010

(30) Foreign Application Priority Data
Oct. 8, 2010 (TW) 099134349

(51) Int. Cl. G06F 17/00

(52) U.S. Cl. 463/37

(57) ABSTRACT

A separable game controller includes a first handle, a second handle and a fixing member. The second handle includes a first sensor, a second sensor and a first controlling unit. The first controlling unit is electrically connected with the first sensor and the second sensor. The first sensor is used for sensing whether the first handle and the second handle are separated from each other. When the first handle and the second handle are separated from each other, the first sensor generates a first signal. When the first signal is received by the first controlling unit, the second sensor is enabled by the first controlling unit to generate a second signal. According to the second signal, a displacement of the second handle is sensed by the second sensor.

### FIELD OF THE INVENTION

The present invention relates to a game controller, and more particularly to a separable game controller.

### BACKGROUND OF THE INVENTION

As the game controllers are designed in views of diversification, separable game controllers become common game controlling devices. FIG. 1A is a schematic diagram perspective view illustrating a conventional game controller in a separating state. FIG. 1B is a schematic diagram perspective view illustrating the conventional game controller of FIG. 1A in a combining state. Please refer to FIGS. 1A and 1B. The conventional game controller 10 comprises a first main body part 11, a second main body part 12 and two fixing members 13 and 14. The fixing members 13 and 14 are disposed on the first main body part 11 and the second main body part 12, respectively. Via the fixing members 13 and 14, the first main body part 11 and the second main body part 12 may be combined together.

In practice, the first main body part 11 and the second main body part 12 may be either separated from or combined with each other according to the palms of the user. For example, in a case that the palms of the user are too large, the game controller 10 of FIG. 1B in the combining state is not feasible to be collectively held by both hands of the user. Under this circumstance, the first main body part 11 and the second main body part 12 of the game controller 10 may be operated in the separating state by detaching the fixing members 13 and 14 from each other. As shown in FIG. 1A, in a case that the first main body part 11 and the second main body part 12 are held by both hands of the user, the user with the large palms can easily operate the game controller 10.

With increasing development of science and technology, there is a great advancement in the image and acousto-optic effects of the computer games. Nowadays, the computer games are designed according to a body-motion controlling technology in order to enhance the reality sense of playing the computer games. Moreover, for enhancing playability and amusement of the computer games, a 3D scene is usually established to support multi-view efficacy in the computer games. In addition, as the degree of virtual realty of the computer game increases, the game instructions to be operated gradually increase. That is, for implementing various controlling operations of the computer games, it is necessary to install more keys on the game controller 10 or set more composite keys.

Take a common third person shooter (TPS) game for example. In the TPS game, the player character may execute many action instructions to create diversified actions such as walking, running, shooting enemies, opening fire, switching weapons, changing the visual angle of the player character, or the like. For example, for playing the TPS game, the user needs to operate the left analog stick L3 to control the motion (e.g. a running action or a walking action) of the player character while operating the right analog stick R3 to adjust the sight to aim at the enemy. During the shooting process, the user may press the first right button R1 to open fire, or the user may press the first left button L1 to select another weapon to play the game. In addition, the user may operate the second left button L2 or the second right button R2 to change the visual angle of the player character to prevent from assault of the enemy that is outside the vision line. Alternatively, the user may operate the direction button 111 to switch an auxiliary device (e.g. a sniper scope or a night-vision scope) to comply with different game scenes. However, too many buttons become hindrance from operating the game controller and increase the possibility of hurting the user's hands.

### SUMMARY OF THE INVENTION

It is an object of the present invention provides a mode-changeable and separable game controller.

In accordance with an aspect of the present invention, there is provided a separable game controller. The separable game controller includes a first handle, a second handle and a fixing member. The first handle includes a direction button. The second handle includes an operating button, a first sensor, a second sensor and a first controlling unit. The first sensor is used for sensing whether the first handle and the second handle are separated from each other. When the first handle and the second handle are separated from each other, the first sensor generates a first signal. The second sensor is disposed within the second handle for sensing a displacement of the second handle. The first controlling unit is electrically connected with the first sensor and the second sensor. When the first signal is received by the first controlling unit, the second sensor is enabled by the first controlling unit to generate a second signal. The fixing member is used for connecting the first handle with the second handle.

In an embodiment, the fixing member includes Velcro fasteners, magnets, an assembly of a convex structure and a concave structure, or a combination thereof.

In an embodiment, the first sensor is a Hall sensor.

In an embodiment, the second sensor is a G-sensor, an accelerometer, a gyroscope, or a combination thereof.

In an embodiment, the second signal is an acceleration signal for controlling a prop shown on a computer game screen.

In an embodiment, the operating button is electrically connected with the first controlling unit. The operating button is operable in either a first operating mode or a second operating mode. When the first handle and the second handle are combined together, the operating button is triggered to execute a function of the first operating mode. Whereas, when the first handle and the second handle are separated from each other, the operating button is triggered to execute a function of the second operating mode.

In an embodiment, the first handle further includes a third sensor, a fourth sensor and a second controlling unit. The third sensor is used for sensing whether the first handle and the second handle are separated from each other. When the first handle and the second handle are separated from each other, the third sensor generates a third signal. The fourth sensor is disposed within the first handle for sensing a displacement of the first handle. The second controlling unit is electrically connected with the third sensor and the fourth sensor. When the third signal is received by the second controlling unit, the fourth sensor is enabled by the second controlling unit to generate a fourth signal.

In an embodiment, the third sensor is a Hall sensor.

In an embodiment, the fourth sensor is a G-sensor, an accelerometer, a gyroscope, or a combination thereof.

In an embodiment, the fourth signal is an acceleration signal for controlling a visual angle of a player character shown on a computer game screen.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic diagram perspective view illustrating a conventional game controller in a separating state;

FIG. 1B is a schematic diagram perspective view illustrating the conventional game controller of FIG. 1A in a combining state;

FIG. 2A is a schematic diagram perspective view illustrating a game controller in a combining state according to an embodiment of the present invention;

FIG. 2B is a schematic diagram perspective view illustrating the game controller of FIG. 2A in a separating state;

FIG. 3 is a schematic diagram illustrating the use of the game controller to control a menu according to the present invention;

FIG. 4 is a schematic functional block diagram illustrating a game controller according to a first embodiment of the present invention;

FIG. 5 is a schematic diagram illustrating the use of the game controller to control a computer game screen according to the first embodiment of the present invention;

FIG. 6 is a schematic functional block diagram illustrating a game controller according to a second embodiment of the present invention;

FIG. 7 is a schematic diagram illustrating the use of the game controller to control a computer game screen according to the second embodiment of the present invention;

FIG. 8 is a schematic functional block diagram illustrating a game controller according to a third embodiment of the present invention; and

FIGS. 9A-9C are schematic diagrams illustrating the use of the game controller to control a computer game screen according to the third embodiment of the present invention.

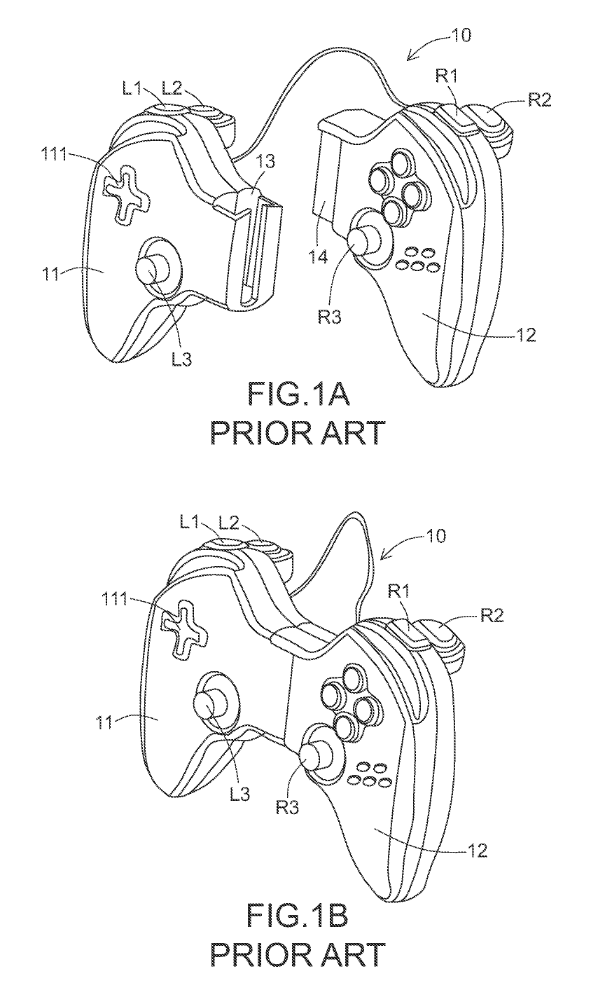

### DETAILED DESCRIPTION OF THE PREFERRED EMBODIMENT

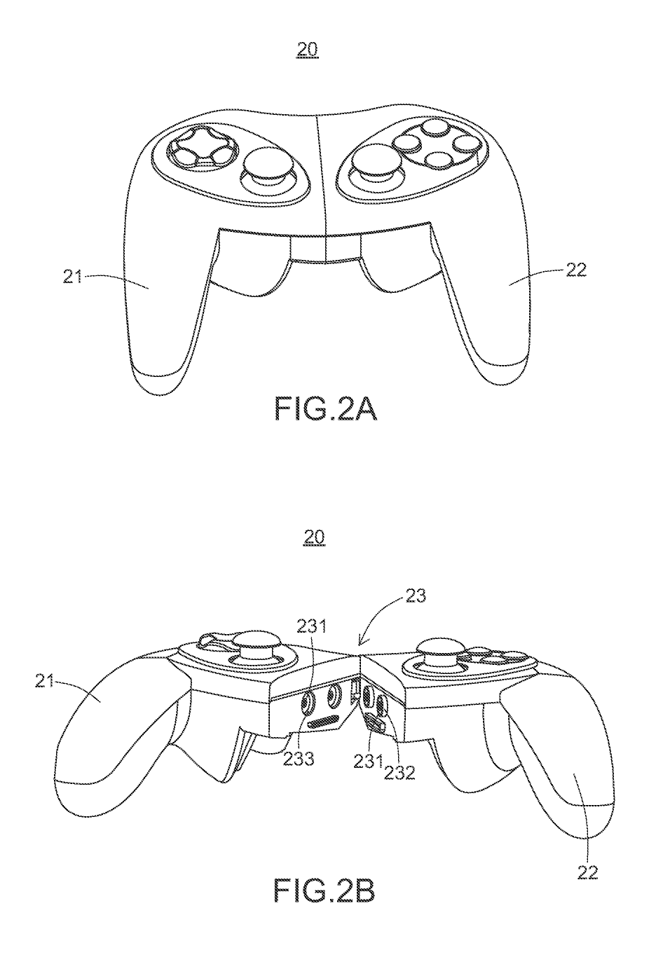

FIG. 2A is a schematic diagram perspective view illustrating a game controller in a combining state according to an embodiment of the present invention. FIG. 2B is a schematic diagram perspective view illustrating the game controller of FIG. 2A in a separating state. Please refer to FIGS. 2A and 2B. The game controller 20 of the present invention comprises a first handle 21, a second handle 22 and a fixing member 23. Through the fixing member 23, the first handle 21 and the second handle 22 may be combined with each other. In this embodiment, the fixing member 23 comprises two magnets 231, a convex structure 232 and a concave structure 233. One of the magnets 231 is disposed on the convex structure 232, and the other of the magnets 231 is disposed within the concave structure 233. When the convex structure 232 is inserted into the concave structure 233, the magnets 241 are magnetically attracted with each other, so that the convex structure 232 is securely fixed in the concave structure 233. It is noted that numerous modifications and alterations of the fixing member 23 may be made while retaining the teachings of the invention. For example, the fixing member 23 may includes two Velcro fasteners, which are respectively disposed on corresponding locations of the first handle 21 and the second handle 22.

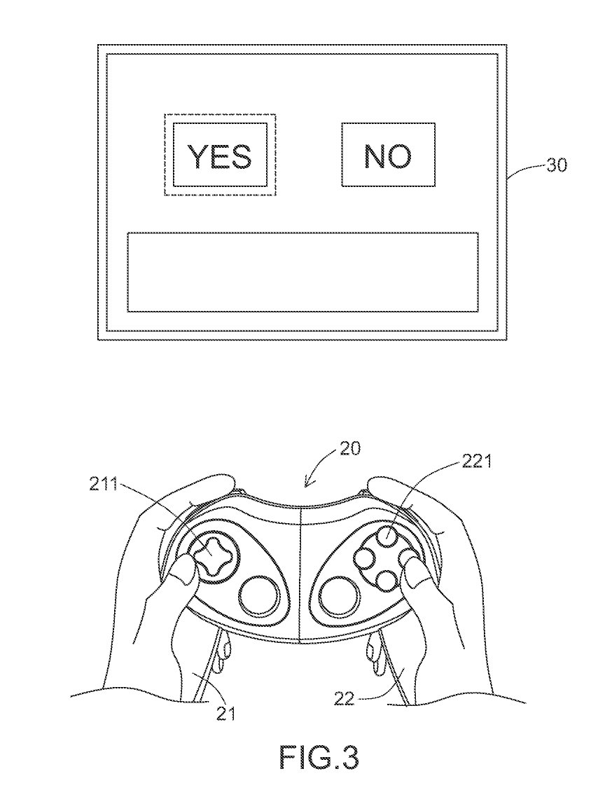

Please refer to FIG. 3. FIG. 3 is a schematic diagram illustrating the use of the game controller to control a menu according to the present invention. The first handle 21 comprises a direction button 211 for controlling a selective item to be moved in an upward, downward, leftward or rightward direction. The second handle 22 comprises an operating button 221 for executing different instructions (e.g. the instructions of confirming or cancelling a selective item). When the first handle 21 and the second handle 22 are combined together, the game controller 20 enters a first operating mode. In this embodiment, the first operating mode is a menu mode. In this situation, the user may manipulate the direction button 211 to lock one selective item shown on the computer game screen 30, and then manipulate the operating button 221 to confirm or cancel the selective item.

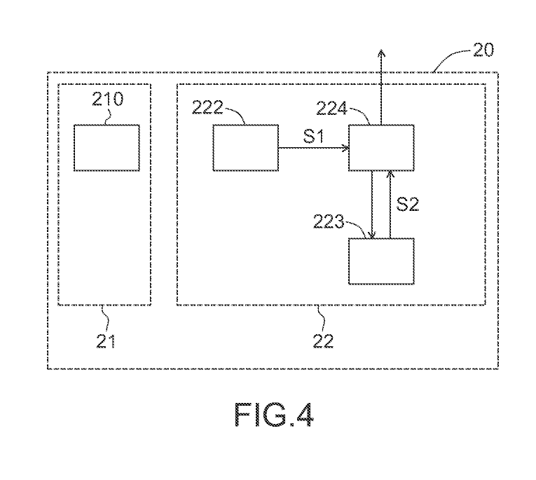

FIG. 4 is a schematic functional block diagram illustrating a game controller according to a first embodiment of the present invention. The first handle 21 of the game controller 20 comprises a magnetic element 210. The second handle 22 of the game controller 20 comprises a first sensor 222, a second sensor 223 and a first controlling unit 224. The first controlling unit 224 is electrically connected with the first sensor 222 and the second sensor 223.

In this embodiment, the first sensor 222 is a Hall sensor for sensing a change of a magnetic field, and generating an output voltage according to the magnetic field. In a case that the first handle 21 and the second handle 22 are combined together, the second sensor 223 is disabled, and thus no signal is generated. Whereas, in a case that the first handle 21 and the second handle 22 are separated from each other, the magnetic element 210 is distant from the second handle 22 to result in a magnetic field change. In response to the magnetic field change, the first sensor 222 issues a first signal S1 to the first controlling unit 224. After the first signal S1 is received, the first controlling unit 224 enables the second sensor 223 to sense a displacement of the second handle 22.

In this embodiment, the second sensor 223 is a G-sensor, an accelerometer, a gyroscope, or a combination thereof. After the second sensor 223 is enabled, the second sensor 223 issues a second signal S2 (e.g. an acceleration signal) according to the displacement of the second handle 22. The second signal S2 is sent back to the first controlling unit 224. According to the second signal S2, the prop shown on the computer game screen 30 will be controlled.

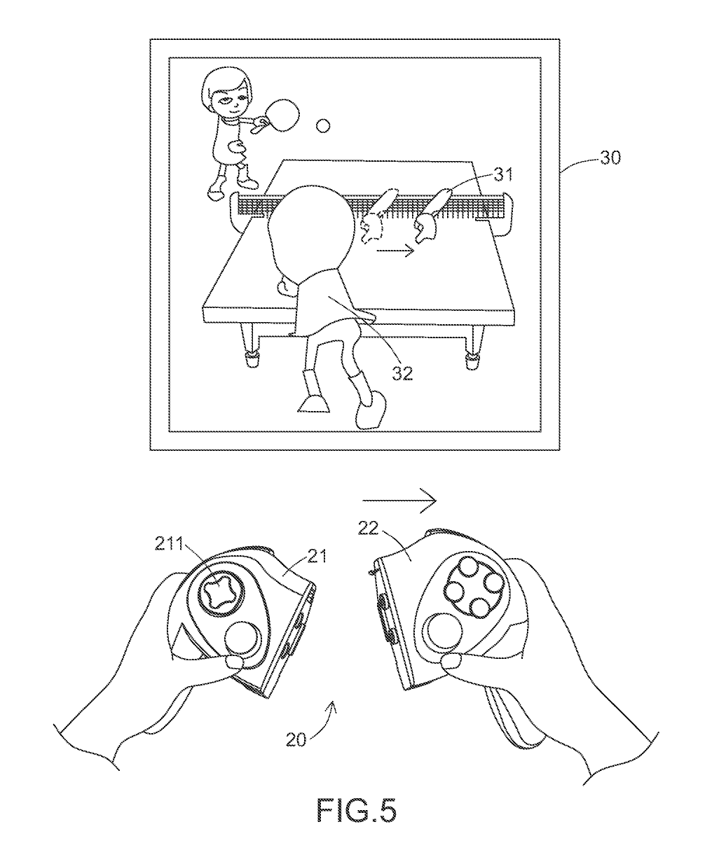

FIG. 5 is a schematic diagram illustrating the use of the game controller to control a computer game screen according to the first embodiment of the present invention. The prop to be controlled includes for example a weapon or ball equipment. For example, the prop is a fist, a knife, a sword, a table tennis racket 31 or any article which is controlled to move by swinging. In FIG. 5, the prop is illustrated by referring to a table tennis racket 31.

Please refer to FIG. 5 again. In a case that the first handle 21 and the second handle 22 of the game controller 20 are separated from each other, the second sensor 223 is enabled. Moreover, by using the second sensor 223 to sense the linear displacement, the angular displacement or the combination thereof, the action of the table tennis racket 31 shown on the computer game screen 30 will be correspondingly controlled. By swinging the second handle 22 toward the right side, the table tennis racket 31 shown on the computer game screen 30 will be moved toward the right side. Moreover, the user may manipulate the direction button 211 of the first handle 21 to move the player character 32 shown on the computer game screen 30 in a specified direction.

In the above embodiment, the user may swing the second handle 22 to adjust the direction and velocity of swinging the table tennis racket 31. Alternatively, by rotating the second handle 22, the racket angle of the table tennis racket 31 can be changed to perform finer gaming actions (e.g. a chopping action, a spinning action or a backhand hitting action).

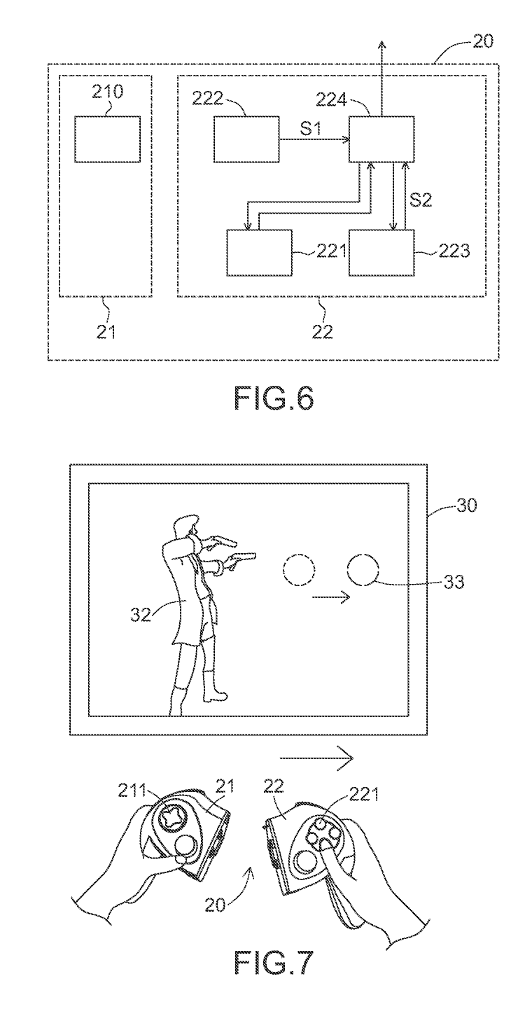

Hereinafter, a second embodiment of the present invention will be illustrated with reference to FIG. 6. FIG. 6 is a schematic functional block diagram illustrating a game controller according to a second embodiment of the present invention. The first handle 21 of the game controller 20 comprises a magnetic element 210. The second handle 22 of the game controller 20 comprises an operating button 221, a first sensor 222, a second sensor 223 and a first controlling unit 224. The first controlling unit 224 is electrically connected with the operating button 221, the first sensor 222 and the second sensor 223. Except that the operating button 221 of the second handle 22 is also electrically connected with the first controlling unit 224 and controlled by the first controlling unit 224, the operating principles and configurations of the game controller 20 of the second embodiment (see FIG. 6) are similar to those of the first embodiment (see FIG. 4), and are not redundantly described herein. In a case that the first handle 21 and the second handle 22 are separated from each other, the magnetic element 210 is distant from the second handle 22 to result in a magnetic field change. In response to the magnetic field change, the first sensor 222 issues a first signal S1 to the first controlling unit 224. After the first signal S1 is received, the first controlling unit 224 will enable the second sensor 223 and switch the function of the operating button 221 from a first operating mode (e.g. the menu mode of FIG. 3) to a second operating mode. For example, the second operating mode is a battle mode. In the battle mode, the user may manipulate the operating button 221 to implement an attacking action of opening fire, throwing weapons or changing weapons. In other words, the game controller 20 of this embodiment is suitable to the computer game with a basic mode and a battle mode (e.g. a turn-based strategy game).

For example, for performing the basic mode of the computer game to get into conversation with a non-player character (NPC), the game controller 20 may be operated in a combining state (see FIG. 3). The first handle 21 comprises a direction button 211 for controlling a selective item to be moved in an upward, downward, leftward or rightward direction. The second handle 22 comprises an operating button 221 for executing different instructions (e.g. the instructions of confirming or cancelling a selective item).

On the other hand, in a case that an enemy appears in the computer game screen 30, the operations of the computer game in the battle mode will be illustrated with reference to FIG. 7. FIG. 7 is a schematic diagram illustrating the use of the game controller to control a computer game screen according to the second embodiment of the present invention. In this situation, the game controller 20 is operated in the separating state to enable the second sensor 223. By using the second sensor 223 to sense a displacement of the second handle 22, the prop shown on the computer game screen 30 can be correspondingly controlled. For example, the prop to be controlled is a sight 33. By moving the second handle 22 toward the right side, the sight 33 shown on the computer game screen 30 will be moved toward the right side with the second handle 221. Moreover, when the game controller 20 is operated in the separating state, the function of the operating button 221 is automatically switched from the menu mode to the battle mode. Meanwhile, the function of opening fire may be executed by pressing the operating button 221.

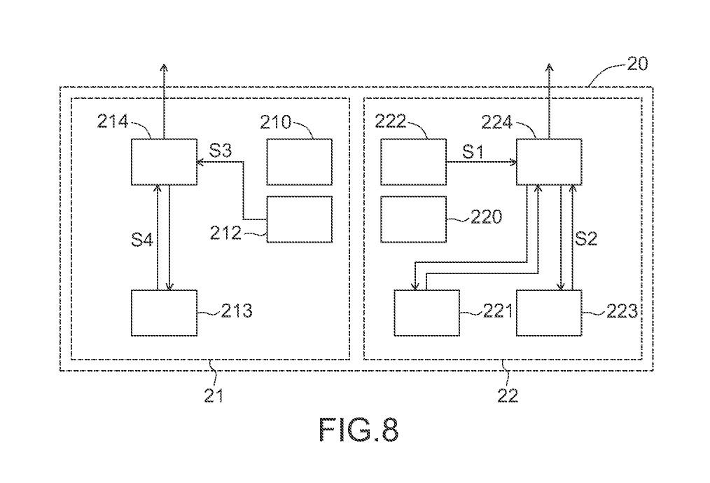

Hereinafter, a third embodiment of the present invention will be illustrated with reference to FIG. 8. FIG. 8 is a schematic functional block diagram illustrating a game controller according to a third embodiment of the present invention. The first handle 21 of the game controller 20 comprises a magnetic element 210, a third sensor 212, a fourth sensor 213 and a second controlling unit 214. The second handle 22 of the game controller 20 comprises a magnetic element 220, an operating button 221, a first sensor 222, a second sensor 223 and a first controlling unit 224. The first controlling unit 224 is electrically connected with the operating button 221, the first sensor 222 and the second sensor 223. The second controlling unit 214 is electrically connected with the third sensor 212 and the fourth sensor 213. Except that the first handle 21 further comprises the third sensor 212 and the fourth sensor 213 and the second handle 22 further comprises the magnetic element 220, the operating principles and configurations of the game controller 20 of the third embodiment (see FIG. 8) are similar to those of the second embodiment (see FIG. 6), and are not redundantly described herein. In this embodiment, the third sensor 212 is a Hall sensor for sensing a change of a magnetic field, and generating an output voltage according to the magnetic field. In a case that the first handle 21 and the second handle 22 are separated from each other, the magnetic element 220 is distant from the first handle 21 to result in a magnetic field change. In response to the magnetic field change, the third sensor 212 issues a third signal S3 to the second controlling unit 214. After the third signal S3 is received, the second controlling unit 214 enables the fourth sensor 213 to sense a displacement of the first handle 21.

In this embodiment, the fourth sensor 213 is a G-sensor, an accelerometer, a gyroscope, or a combination thereof. After the fourth sensor 213 is enabled, the fourth sensor 213 issues a fourth signal S4 (e.g. an acceleration signal) according to the displacement of the first handle 21. The fourth signal S4 is sent back to the second controlling unit 214. According to the fourth signal S4, the visual angle of the player character 32 shown on the computer game screen 30 will be controlled. The game controller 20 of this embodiment is suitable to the computer game with more instructions (e.g. a third person shooter game).

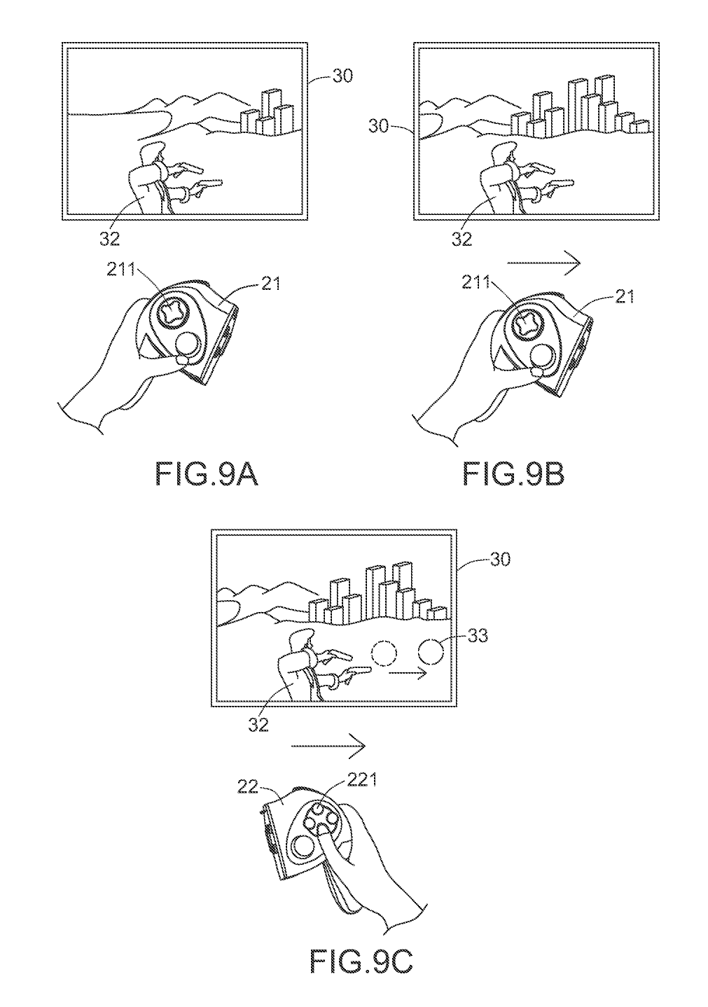

For example, for performing a computer game with less instructions (e.g. a 2D side-scrolling game), the game controller 20 may be operated in a combining state (see FIG. 3). The first handle 21 comprises a direction button 211 for controlling a selective item to be moved in an upward, downward, leftward or rightward direction. The second handle 22 comprises an operating button 221 for executing different instructions (e.g. the instructions of confirming or cancelling a selective item).

Whereas, for performing a computer game with more instructions (e.g. a third person shooter game), the player character manipulated by the user can directly attack the enemy in the 3D scene without the need of entering the battle mode of the turn-based strategy game. In this embodiment, the game controller 20 in the separating state may be used to play such computer game. As shown in FIGS. 9A and 9C, the second sensor 223 and the fourth sensor 213 are used to sense the displacement amounts of the second handle 22 and the first handle 21, respectively.

FIGS. 9A-9C are schematic diagrams illustrating the use of the game controller to control a computer game screen according to the third embodiment of the present invention. As shown in FIGS. 9A and 9B, the first handle 21 may be used to control the visual angle of the player character 32 shown on the computer game screen 30. By swinging the first handle 21 toward the right side, the visual angle of the player character 32 shown on the computer game screen 30 is switched (e.g. from FIG. 9A to FIG. 9B). At the same time, the user may manipulate the direction button 211 of the first handle 21 to control movement of the player character 32. In such way, the user may quickly change the visual angle of the player character 32 and move the player character 32 while preventing from being attacked by the enemy outside the vision line.

As shown in FIG. 9C, the user may manipulate the second handle 22 to control the prop (e.g. a sight 33) shown on the computer game screen 30. By moving the second handle 22 toward the right side, the sight 33 shown on the computer game screen 30 will be moved toward the right side with the second handle 22. Moreover, when the game controller 20 is operated in the separating state, the function of the operating button 221 is automatically switched from the first operating mode (i.e. the menu mode) to the second operating mode (i.e. the battle mode). Meanwhile, the function of opening fire may be executed by pressing the operating button 221.

From the above three embodiments, the first handle 21 and the second handle 22 of the separable game controller 20 of the present invention may be combined together or separated from each other. By detecting whether the first handle 21 and the second handle 22 are separated from each other, the function of the first handle 21 or the second handle 22 will be adjusted. In such way, various gaming instruction may be executed without the need of manipulating too many buttons. That is, by using the game controller of the present invention, the operations of the computer game will be simplified, the computer game can be played in a more intuitive manner, the entertainment of playing the computer game will be enhanced, and the possibility of hurting the user's hands will be minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A separable game controller, comprising:
a first handle comprising a direction button;
a second handle comprising:
an operating button;
a first sensor for sensing whether said first handle and said second handle are separated from each other, wherein when said first handle and said second handle are separated from each other, said first sensor generates a first signal;
a second sensor disposed within said second handle for sensing a displacement of said second handle; and
a first controlling unit electrically connected with said first sensor and said second sensor, wherein when said first signal is received by said first controlling unit, said second sensor is enabled by said first controlling unit to generate a second signal; and
a fixing member for connecting said first handle with said second handle.

2. The separable game controller according to claim 1 wherein said fixing member includes Velcro fasteners, magnets, an assembly of a convex structure and a concave structure, or a combination thereof.

3. The separable game controller according to claim 1 wherein said first sensor is a Hall sensor.

4. The separable game controller according to claim 1 wherein said second sensor is a G-sensor, an accelerometer, a gyroscope, or a combination thereof.

5. The separable game controller according to claim 1 wherein said second signal is an acceleration signal for controlling a prop shown on a computer game screen.

6. The separable game controller according to claim 1 wherein said operating button is electrically connected with said first controlling unit, and operable in either a first operating mode or a second operating mode, wherein when said first handle and said second handle are combined together, said operating button is triggered to execute a function of said first operating mode, wherein when said first handle and said second handle are separated from each other, said operating button is triggered to execute a function of said second operating mode.

7. The separable game controller according to claim 1 wherein said first handle further comprises:
a third sensor for sensing whether said first handle and said second handle are separated from each other, wherein when said first handle and said second handle are separated from each other, said third sensor generates a third signal;
a fourth sensor disposed within said first handle for sensing a displacement of said first handle; and
a second controlling unit electrically connected with said third sensor and said fourth sensor, wherein when said third signal is received by said second controlling unit, said fourth sensor is enabled by said second controlling unit to generate a fourth signal.

8. The separable game controller according to claim 7 wherein said third sensor is a Hall sensor.

9. The separable game controller according to claim 7 wherein said fourth sensor is a G-sensor, an accelerometer, a gyroscope, or a combination thereof.

10. The separable game controller according to claim 7 wherein said fourth signal is an acceleration signal for controlling a visual angle of a player character shown on a computer game screen.
